(19) United States
(12) Patent Application Publication
(10) Pub. No.: US 2009/0039123 A1
(43) Pub. Date: Feb. 12, 2009

(54) Laptop Computer Carrying Articles And Methods Of Manufacturing The Same

(75) Inventors: Barry Sween, Santa Monica, CA (US); Mike Simonian, San Francisco, CA (US); Maaike Evers, San Francisco, CA (US)

Correspondence Address: Pedro J. Rivera;Bryan Cave LLP, Suite 2200, Two North Central Avenue, Phoenix, AZ, 85004, US

(73) Assignee: Belkin International, Inc., Compton, CA (US)

(21) Appl. No.: 12/188,616

(22) Filed: Aug. 8, 2008

Related U.S. Application Data
(60) Provisional application No. 60/955,000, filed on Aug. 9, 2007.

(51) Int. Cl. A45F 3/14; B23P 17/00

(52) U.S. Cl. 224/250; 29/592

(57) ABSTRACT

Embodiments of laptop computer carrying articles and methods of manufacture thereof are generally described herein. An article for carrying a laptop computer generally comprises a body having a non-secured opening, and a support strap coupled to the body. The non-secured opening comprises dimensions at least as large as at least two of a laptop width, a laptop height, or a laptop thickness. The body further comprises a first side having a substantially uninterrupted surface, and a second side opposite the first side and comprising the non-secured opening. The support strap is integral with at least one of the first or second sides of body. Other embodiments may be described and claimed herein.

### CROSS REFERENCE TO RELATED APPLICATIONS

This application is a non-provisional application claiming priority to U.S. Provisional Patent Application No. 60/955,000, filed on Aug. 9, 2008, which is incorporated herein by reference.

### TECHNICAL FIELD

This disclosure generally relates to an article to securely carry or transport an electronic device and accessories. More specifically, this disclosure relates to a shoulder bag or backpack type article having an interior storage space for a laptop computer, and additional interior storage space for personal items and/or the laptop computer's accessories.

### BACKGROUND

A laptop computer is often used in an out-of-office environment, and the compact nature and mobility of the laptop computer allows the user to operate his computer, for example, during travel, in an outside environment, while sitting in a chair, and the like. Laptops, however, can often be difficult or inconvenient to tote it in a traditional fashion, such as in a cumbersome laptop computer bag. Moreover, a computer bag is typically unfashionable, lacks aesthetic appeal, and/or provides minimal user functionality. An article such as a shoulder bag or a backpack to securely transport a laptop computer along with various other personal items is desirable. Moreover, a shoulder bag or a backpack that may incorporate current fashion trends, exhibit greater aesthetic appeal, and provide more functionality than a typical laptop computer bag is likewise desirable.

### BRIEF DESCRIPTION OF THE DRAWINGS

FIG. 1 illustrates an isometric view of an exemplary laptop computer carrying article according to a first embodiment of the invention.

FIG. 2 illustrates a second isometric view of the exemplary laptop computer carrying article of FIG. 1.

FIG. 3 illustrates an exploded view of the exemplary laptop computer carrying article of FIGS. 1 and 2.

FIG. 4 illustrates a front view of an exemplary laptop computer carrying article according to a second embodiment of the invention.

FIG. 5 illustrates a back view of an exemplary laptop computer carrying article according to a third embodiment of the invention.

FIG. 6 illustrates a back view of an exemplary laptop computer carrying article according to a fourth embodiment of the invention.

FIG. 7 illustrates a front view of an exemplary laptop computer carrying article according to a fifth embodiment of the invention.

FIG. 8 illustrates a back view of the exemplary laptop computer carrying article of FIG. 7.

FIG. 9 illustrates an exploded view of the exemplary laptop computer carrying article of FIGS. 7 and 8.

FIG. 10 illustrates an isometric view of a sleeve for an interior body of an exemplary laptop computer carrying article according to a sixth embodiment of the invention.

FIG. 11 illustrates an isometric view of a sleeve for an interior body of an exemplary laptop computer carrying according to a seventh embodiment of the invention.

FIG. 12 illustrates an isometric view of an exemplary laptop computer carrying article according to an eighth embodiment of the invention.

FIG. 13 illustrates an isometric view of an exemplary laptop computer carrying article according to a ninth embodiment of the invention.

FIG. 14 illustrates an isometric view of an exemplary accessory folder of an exemplary laptop computer carrying article according to a tenth embodiment of the invention.

FIG. 15 illustrates an isometric view of the exemplary accessory folder of FIG. 14.

FIG. 16 depicts a flow diagram representation of a manner in which an exemplary laptop computer carrying article can be manufactured, according to an embodiment.

FIG. 17 illustrates an isometric view of an exemplary laptop computer carrying article with a single support strap according to another embodiment.

FIG. 18 illustrates a front isometric view of the article of FIG. 17 with closed flap.

FIG. 19 illustrates a rear isometric view of the article of FIG. 17 with open flap.

FIG. 20 illustrates a view of compartments inside the article of FIG. 17.

FIG. 21 shows a side view of the article of FIG. 17 showing a stowable compartment as exposed.

For simplicity and clarity of illustration, the drawing figures illustrate a general manner of construction, and descriptions and details of well-known features and techniques can be omitted to avoid unnecessarily obscuring a laptop computer carrying article. Additionally, elements in the drawing figures are not necessarily drawn to scale. For example, the dimensions of some of the elements in the figures may be exaggerated relative to other elements to help improve understanding of embodiments of the laptop computer carrying articles and methods of manufacturing the same. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of laptop computer carrying articles and methods of manufacturing the same as described herein are, for example, capable of operation in sequences other than those illustrated or otherwise described herein. Furthermore, the terms “contain,” “include,” and “have,” and any variations thereof, are intended to cover a non-exclusive inclusion, such that a process, method, article, or apparatus that comprises a list of elements is not necessarily limited to those elements, but can include other elements not expressly listed or inherent to such process, method, article, or apparatus.

The terms “left,” “right,” “front,” “back,” “top,” “bottom,” “side,” “under,” “over,” and the like in the description and in the claims, if any, are used for descriptive purposes and not necessarily for describing permanent relative positions. It is to be understood that the terms so used are interchangeable under appropriate circumstances such that the embodiments of laptop computer carrying articles and methods of manufacturing the same as described herein are, for example, capable of operation in orientations other than those illustrated or otherwise described herein. The term “coupled,” as used herein, is defined as directly or indirectly connected in a physical, mechanical, or other manner.

### DESCRIPTION OF EXAMPLES OF EMBODIMENTS

In a first embodiment of a laptop computer carrying article, an article for carrying a laptop computer generally comprises a body having a non-secured opening, and a support strap coupled to the body. The non-secured opening comprises dimensions at least as large as at least two of a laptop width, a laptop height, or a laptop thickness. The body further comprises a first side having a substantially uninterrupted surface, and a second side opposite the first side and comprising the non-secured opening. The support strap is integral with at least one of the first or second sides of body. Other embodiments may be described and claimed herein.

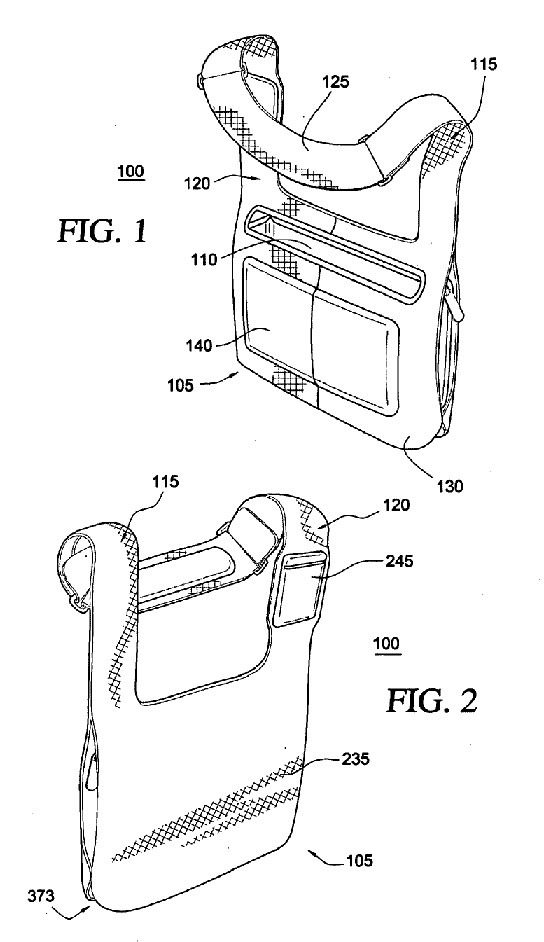

Turning now to the figures, FIG. 1 illustrates an isometric view of an exemplary laptop computer carrying article 100 according to an embodiment of the invention. In this exemplary embodiment, article 100 comprises a body 105 having a non-secured opening 110 at a back side 130 to provide access to an interior of body 105. Non-secured opening 110 can be used, for example, to insert a laptop (not shown) into body 105 of article 100. In the same or a different embodiment, non-secured opening 110 comprises dimensions at least as large as at least two of a laptop width, a laptop height, and a laptop thickness. In the same or a different embodiment, the laptop width, height, and/or thickness can be based on dimensions of laptops commonly found in the market and/or of a particular laptop.

Article 100 further comprises a support strap 115 and a support strap 120 to facilitate carrying article 100. Article 100 also comprises a support strap 125 coupled at one end to support strap 115 and coupled at the other end to support strap 120 to further facilitate carrying article 100. In the present embodiment, support straps 115 and 120 are removably coupled together through support strap 125. In a different embodiment, two or more of support straps 115, 120, and 125 can be coupled together in a substantially permanent manner. In some embodiments, support straps 115, 120, and/or 125 can be portions of a single strap. When support straps are coupled together, the combination of their respective lengths can be referred to as an overall length. Support straps 115, 120, and 125 are described in greater detail below.

Body 105 further comprises padding 140 to provide cushioning between article 100 and a user when the user wears article 100 according to its intended use. Padding 140 is likewise described in greater detail below.

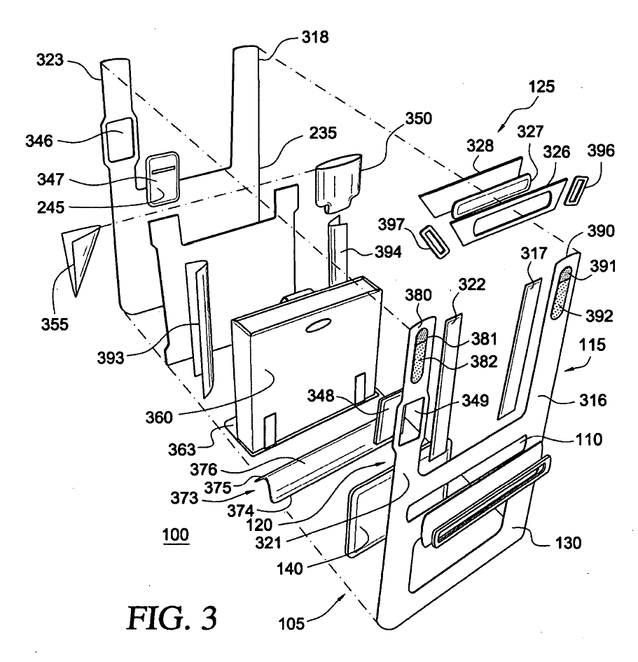

FIG. 2 illustrates a second isometric view of the laptop computer carrying article 100 of FIG. 1, wherein body 105 comprises a front side 235 opposite back side 130. In the present embodiment, front side 235 comprises a substantially continuous and uninterrupted surface. In some embodiments, back side 130 can be referred to as a user side, being intended to be worn facing a user. Similarly, in the same or a different embodiment, front side 235 can be referred to as a peripheral side, being intended to be worn away from the user. As can be seen in both FIGS. 1 and 2, article 100 comprises support straps 115 and 120, both being integral with body 105. In the same or a different embodiment, support straps 115 and 120 can be coupled together to form a single support strap, and/or can comprise different portions of the single support strap. Moreover, FIG. 2 illustrates article 100 further comprising storage pocket 245 that can be integral with support strap 120. Storage pocket 245 can be used to carry a portable device, and will be described in greater detail below.

To better understand the various exemplary embodiments described herein, FIG. 3 illustrates an exploded view of exemplary laptop computer carrying article 100 of FIGS. 1 and 2, showing how the various elements described herein can be interrelated. In the present example, article 100 can further comprise a bottle holder 350, an accessory pocket 355, and/or an internal sleeve 360, all of which will be described in greater detail below.

In this exemplary embodiment, body 105 comprises padding 140, and as shown in FIG. 3, padding 140 can be configured between back side 130 and internal sleeve 360. The padding 140 can cushion article 100 between body 105 and the user when the user wears the article according to its intended use. In another embodiment, back side 130 can have a hole in which padding 140 is located.

In the present example, sleeve 360 is configured to be located within the interior of body 105, and can be coupled to non-secured opening 110. Sleeve 360 can be designed to accommodate the laptop width, the laptop height, and/or the laptop thickness of a laptop inserted into sleeve 360 through non-secured opening 110. In some examples, sleeve 360 can comprise cushioning material coupled to its walls. In one embodiment, sleeve 360 can be removable from body 105. In the same or a different embodiment, sleeve 360 can comprise a support element 363 configured to maintain sleeve 360 in an upright position when placed over a support surface such as a table top or a floor.

In the present embodiment, article 100 further comprises support element 373 coupled proximate to a bottom of body 105. Support element 373 can be similar to support element 363, but is configured to maintain article 100 in an upright position when placed over the support surface, regardless of the presence of support element 363. In the present example, support element 373 comprises support spine 376 and support edges 374 and 375 longitudinal to a bottom of article 100. Support edges 374 and 375 are configured to support article 100 in the upright position, maintaining an upright balance of the article. When article 100 is in the upright position, edge 374 sustains a first portion of a weight of article 100 along a first axis over the support surface, while edge 375 sustains a second portion of the weight of article 100 along a second axis over the support surface. Support edges 374 and 375 also raise and maintain support spine 376 off the support surface. Support spine 376 can support at least part of the weight of items within article 100, such as sleeve 360 and any contents within, away from a bottom end of article 100. Support spine 376 can thus restrict bulging or other deformation of article 100 towards the support surface, thereby preventing uneven contact between the bottom of article 100 and the support surface from affecting the upright balance of the article. In some embodiments, support edges 374 and/or 375 can be referred to as support regions.

Among the various embodiments described herein, the laptop computer carrying article can be described as having various features, and many of these features are intended to provide benefits to a user when the user wears the article according to its intended use. In some examples, the laptop computer carrying article is intended to be worn with the non-secured opening towards the user. This positioning provides security for the user because, when the opening is towards the user, others cannot see through the non-secured opening to observe that the user is carrying a laptop computer. Furthermore, the overall configuration of the article, for example, in a shoulder bag or back pack configuration, does not put others on notice that the user is carrying a valuable laptop computer, like a typical computer bag does. For example, others may interpret die shoulder bag or back pack configuration as merely an article for carrying books and/or personal items. Additionally, placing the opening towards the user reduces the likelihood that a thief or pickpocket will be able to steal an item out of the laptop computer carrying article. Moreover, the continuous and uninterrupted side of the article is intended to face away from the user and provide a clean, continuous, fashionable, and aesthetically pleasing look. Also, the various padding described herein is intended to benefit the user when the article is worn according to its intended use, by providing cushioning between, for example, the body of the article and the user, or between the support straps and the user.

Returning now to FIG. 3, support straps 115, 120, and 125 are shown in greater detail. In this exemplary embodiment, support strap 115 further comprises a front side 318 and a back side 316. A padding 317 can be located between front side 318 and back side 316, to provide comfort for the user when carrying article 100. Similarly, support strap 120 further comprises a front side 323, a back side 321, and a padding 322 that can be located between front side 323 and back side 321 to provide comfort for the, user similar to padding 317. Different from support strap 115, however, support strap 120 further comprises portable device storage pocket 245 to store a portable device that can be similar to devices such as an iPOD® device or a cell phone. Storage pocket 245 comprises, in this exemplary embodiment, a front opening 346 in front side 323 of support strap 120, a front panel 347, a padding 348 to cushion contacts or impacts between article 100 and the user, and a back opening 349 in back side 321 of support strap 120. While storage pocket 245 is shown as part of support strap 120, storage pocket 245 can comprise a location other than support strap 120. For example, storage pocket 245 can be situated on support strap 115, or body 105. Moreover, in a different embodiment, storage pocket 245 can be removably coupled to article 100. Additionally, while only one storage pocket 245 is shown, other embodiments can comprise more than one portable device storage, for example, to store both an iPOD® device and a cell phone. In yet another exemplary embodiment, article 100 may not comprise storage pocket 245 at all.

As can be further seen in FIG. 3, article 100 comprises support strap 115 and 120 contiguous with body 105 and seamlessly coupled to body 105. More specifically, front side 318 of support strap 115 is continuous with front side 235 of body 105, and front side 323 of support strap 120 is also continuous with front side 235. In this exemplary embodiment, front sides 318, 323, and 235 can all be cut from the same piece of material. Similarly, back side 316 of support strap 115 is continuous with back side 130 of body 105, and back side 321 of support strap 120 is also continuous with back side 130. In this exemplary embodiment, back sides 316, 321, and 130 can likewise all be cut from the same piece of material. In a different embodiment, front sides 318, 323, and 235 are continuous while back sides 316, 321, and 130 are discontinuous.

In this exemplary embodiment, support straps 115 and 120 further comprise a mechanism for coupling each of straps 115 and 120 to support strap 125. For example, back side 316 of support strap 115 further comprises, adjacent to an end 390, hook-and-loop material with hooks 391 and loops 392. In some embodiments, the hook-and-loop material can be similar to that of the Velcro® brand. Similarly, back side 321 of support strap 120 further comprises, adjacent to an end 380, hooks 381 and loops 382.

Continuing with this exemplary embodiment, and as mentioned above, article 100 further comprises support strap 125. Support strap 125 can be coupled to support strap 115 at end 390, and coupled to second strap 120 at end 380. Similar to support straps 115 and 120, support strap 125 further comprises front side 328 and back side 326. A padding 327 is between front side 328 and back side 326, and padding 327 provides cushioning for a user when carrying article 100. Additionally, support strap 125 comprises connection rings 396 and 397 at either end to facilitate coupling support strap 125 to support straps 115 and 120.

With continued reference to FIG. 3, end 390 of support strap 115 can be fed through the opening of ring 396 and folded over to engage hooks 391 with loops 392. Similarly, end 380 of support strap 120 can be fed through the opening of ring 397 and folded over to engage hooks 381 with loops 382. In this manner, support strap 125 can be coupled to support straps 115 and 120. Moreover, by adjusting the engagement between the hooks and loops, an overall length of coupled support straps 115, 120, and 125 can be adjusted to accommodate the preferences or height of the user. Among the various exemplary embodiments described herein, the coupling and adjusting mechanism is described as comprising hook-and-loop material, but other mechanisms are contemplated, for example, snaps, buttons, ties, and other like fasteners can be used. Also, connection rings 397 and 396, in one embodiment, can comprise anodized aluminum, but in other exemplary embodiments, rings 397 and 396 can comprise other materials, such as plastic, cloth, and the like.

With continued reference to FIG. 3, article 100 comprises side gussets 393 and 394 coupled to and located between front side 235 and back side 130 to facilitate expanding the interior of body 105. Side gussets 393 and 394 can comprise a folded or accordion type configuration, and as article 100 is opened to insert a laptop computer and/or personal items, gussets 393 and 394 can expand to facilitate creating a greater interior volume.

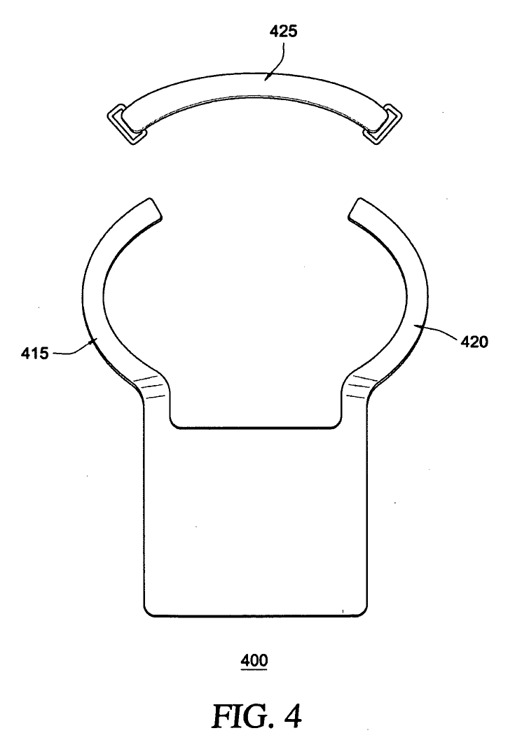

In the exemplary embodiment shown in FIGS. 1-3, support strap 125 comprises a trapezoidal shape, but other shape configurations are contemplated by this disclosure. For example, according to a second embodiment, and with reference to FIG. 4, a laptop computer carrying article 400 is illustrated showing different support strap configurations. For example, a support strap 415 and a support strap 420, similar in function to support straps 115 and 120, respectively, of FIGS. 1-3, are shown comprising an arcuate shape. Also, a support strap 425, similar in function to support strap 125 of FIGS. 1-3, is shown also comprising an arcuate shape. By incorporating arcuate shapes among the various support straps, a more contoured fit can be realized by the user. Also, among the various support straps described herein, other configurations and shapes are also contemplated by this disclosure. In the same or a different embodiment, article 400 can be otherwise similar to article 100 (FIGS. 1-3).

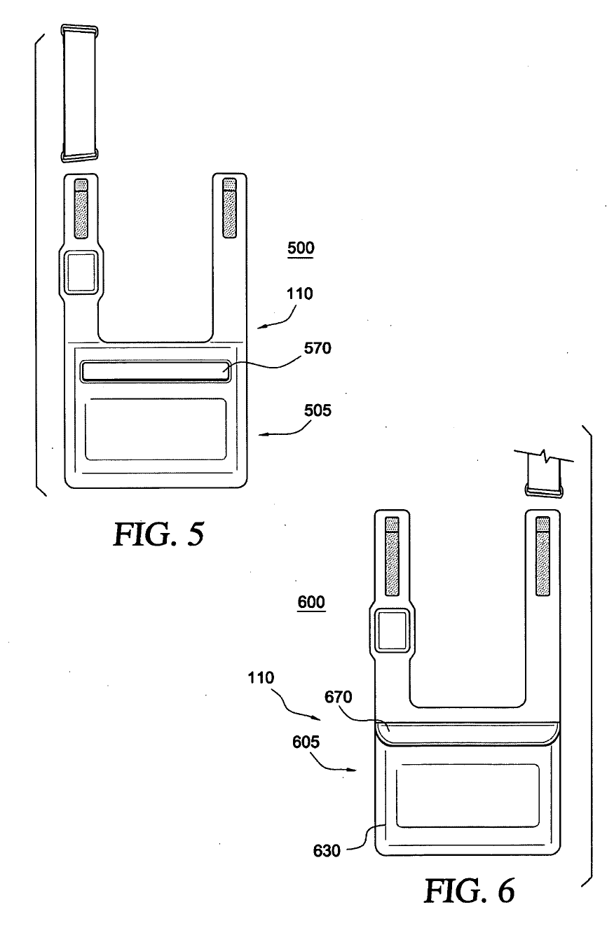

Continuing with the figures, FIG. 5 illustrates a back view of an exemplary laptop computer carrying article 500 according to a third embodiment of the invention. Article 500, which can be similar to articles 100 and 400 of FIGS. 1-4, comprises a flap 570 to cover non-secured opening 110. In this exemplary embodiment, flap 570 can be coupled to a body 505 within non-secured opening 510 and can be allowed to cover non-secured opening 510 and also obstruct access to an interior of body 505.

In accordance with a fourth exemplary embodiment, a back view of laptop computer carrying article 600 is shown in FIG. 6. Article 600 can be similar to articles 100, 400, and 500 of FIGS. 1-5. Article 600 comprises a flap 670 that can be coupled to side 630 of body 605, providing a different manner to cover non-secured opening 110, and also obstructing access to an interior of body 605. Among the various embodiments described herein, a cover can provide additional security by preventing prying eyes of others from seeing into the interior of the body, and also by protecting the interior from outside elements, such as rain, snow, and the like.

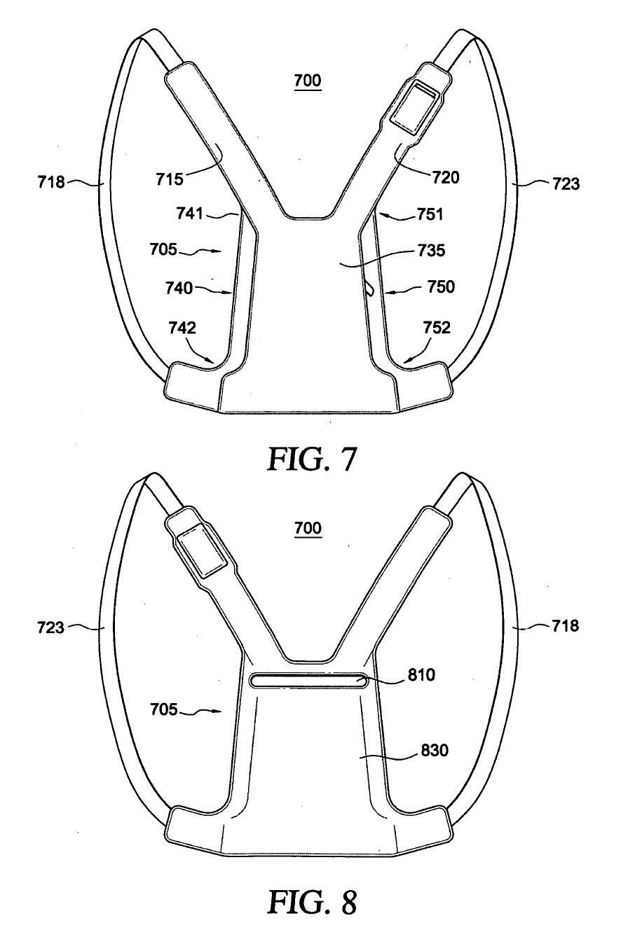

FIG. 7 illustrates a front view of an exemplary laptop computer carrying article 700. Article 700 can be similar to articles 100 (FIGS. 1-3) and/or 400 (FIG. 4). In this exemplary embodiment, however, article 700 comprises a backpack type configuration. Article 700 comprises body 705, and can be similar in function to articles 100, 400, 500, and 600 of FIGS. 1-6. For example, article 700 exhibits a clean, continuous, uninterrupted front side 735, and integral support straps 720 and 715. However, in this exemplary embodiment, there is no third support strap coupled between supports straps 715 and 720. A different configuration is described in greater detail below.

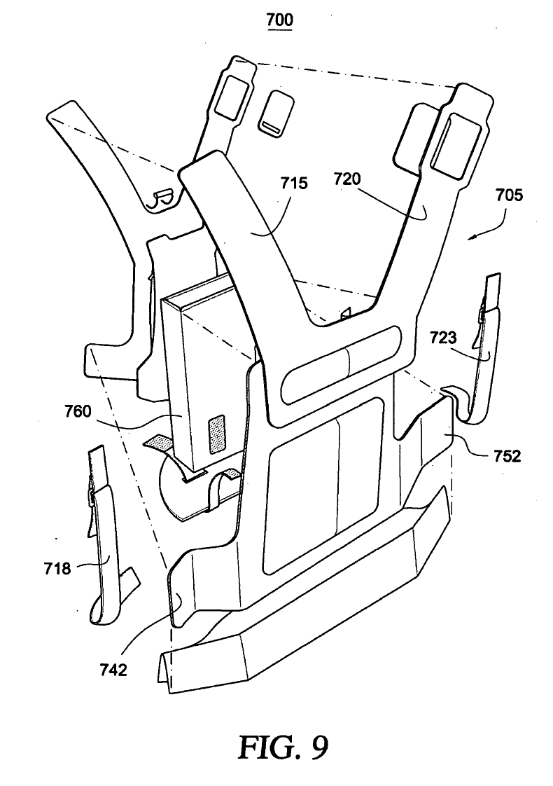

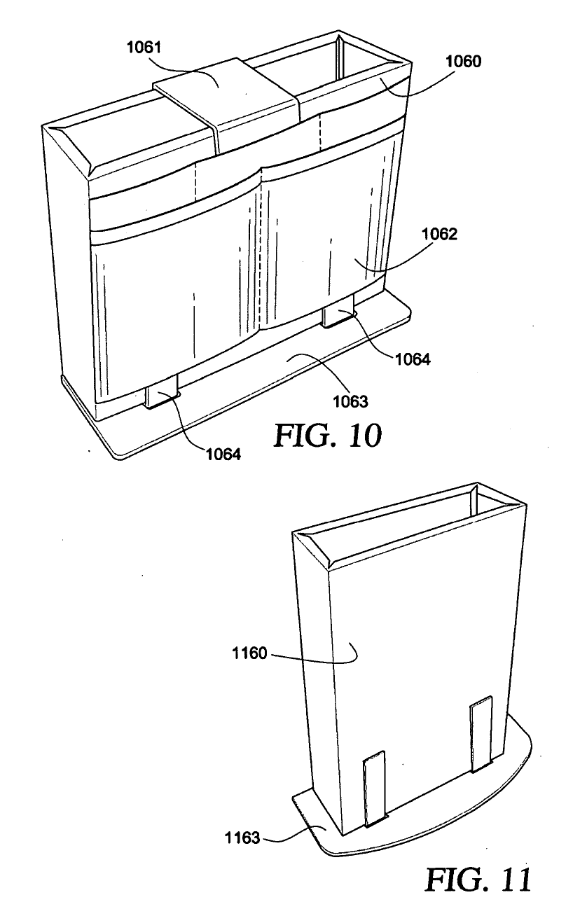

Continuing with the figures, FIG. 8 illustrates a back side 830 of the exemplary laptop computer carrying article 700 of FIG. 7. This embodiment, similar to pervious embodiments discussed herein, comprises an opening 810 to provide access to an interior of a body 805 of article 700. FIG. 9 is yet another illustration of article 700, showing an exploded view of exemplary laptop computer carrying article 700. Article 700 also includes a padding 830 (FIG. 8), which can be similar to padding 140 of article 100 in FIG. 1.

Similar to the exploded view of article 100 in FIG. 3, FIG. 9 illustrates the interrelation among various elements of article 700. For example, article 700 includes an internal sleeve 760, which can be similar to internal sleeve 360 of article 100 in FIG. 3. As illustrated in FIG. 7, article 700 also comprises support strap 715 coupled to body 705 at opposite ends 741 and 742 of lateral portion 740, and support strap 720 coupled to body 705 at opposite ends 751 and 752 of lateral portion 750. Similar to support straps 115, 120, and 125 (FIGS. 1-3), support straps 715 and 720 can be comprised of two or more straps coupled together. For example, article 700 further comprises adjustment strap 718 coupled between support strap 715 and end 742 of body 705, and adjustment strap 723 coupled between support strap 720 and end 752 of body 705.

As mentioned above, article 700 does not comprise a support strap coupled between support straps 715 and 720, as described for corresponding elements of other exemplary embodiments discussed herein. Instead, this exemplary embodiment comprises a support strap 718 coupled to support strap 715 and end 742 of body 705, and a support strap 723 can be coupled to support strap 720 and end 752 of body 705. This configuration allows a user to wear article 700 in a backpack type manner.

According to a sixth embodiment of the invention, FIG. 10 illustrates an isometric view of a sleeve 1060 for use within an interior body of an exemplary laptop computer carrying article, such as articles, 100, 400, 500, and 600 of FIGS. 1-6, and/or article 700 of FIG. 7. Sleeve 1060 can comprise a foam-like cushioning material to protect the laptop computer. Sleeve 1060 can also comprise a size and configuration to safely house a laptop computer, and similar to internal sleeve 360 of article 100, as shown in FIG. 3, sleeve 1060 can be located between an article's front and back sides. Sleeve 1060 can further comprise a closing strap 1061, such that when a laptop computer is placed within sleeve 1060, closing strap 1061 can be secured over the opening to prevent the laptop computer from dislodging from sleeve 1060.

Among the various exemplary embodiments described herein, the cushioning material of an interior sleeve can comprise of a foam-like material such as a closed cell urethane to provide the cushioning function. The interior sleeve can also be rigid while still providing the cushioning function. Other exemplary embodiments, however, can comprise other materials that can provide the cushioning function. For example, other foams, which can include open cell or closed cell configurations, other polymers, rubbers, and the like can be used. Moreover, instead of a cushioning material, other contemplated embodiments can comprise a bladder that can further comprise a filler, such as, a gas, a liquid, a gel, a polymer, and the like, to likewise provide the cushioning function.

Returning to FIG. 10, in this exemplary embodiment, sleeve 1060 can further comprise a storage pocket 1062 at an exterior of sleeve 1060 to house various personal items and/or laptop computer accessories. Moreover, sleeve 1060 can be coupled to a support element 1063 that facilitates maintaining the article in an upright position when the article is placed on the ground in an upright position. By comprising a support element, such as support element 1063, an article can function in a stand-alone upright mode, thereby providing a storing function that is separate from the carrying function. Furthermore, as a result of a minimal footprint created by the article standing in the upright position, the article requires less “floor” space than if the article were laid in a horizontal configuration. Moreover, such a minimal footprint provides beneficial storage where space is at a premium such as in college dormitories, military barracks, office cubicles, small apartments, and the like. In addition, in this exemplary embodiment, the article can provide a concealment function during storage.

Continuing with the exemplary embodiment as shown in FIG. 10, sleeve 1060 can be coupled to support element 1063 to provide a secure configuration and prevent sleeve 1060 from becoming displaced with the article. In this exemplary embodiment, sleeve 1060 can be removably coupled to support 1063 by, for example, hook-and-loop material connections 1064. In this manner, sleeve 1060 can optionally be removed by a user to provide cushioning protection apart from the article. In other exemplary embodiments, when removed form the article, sleeve 1060 can further function to act as a cushioning support for a laptop computer, for example, on a table or desk; or a user's lap. Sleeve 1060 can have a bottom, or support element 1063 can serve as the bottom for sleeve 1060.

Turning now to FIG. 11, FIG. 11 illustrates an isometric view of a sleeve 1160 for an interior body of an exemplary laptop computer carrying article according to a seventh embodiment of the invention. Sleeve 1160 can be similar to sleeve 1060 of FIG. 10, for example, can also be similar to interior sleeve 760 of exemplary article 700 as shown in FIG. 9. Sleeve 1160, similar to sleeve 1060, can be removably coupled to a support element 1163 to provide support for the article when the article is placed in an upright position, similar to support element 1063 (FIG. 10).

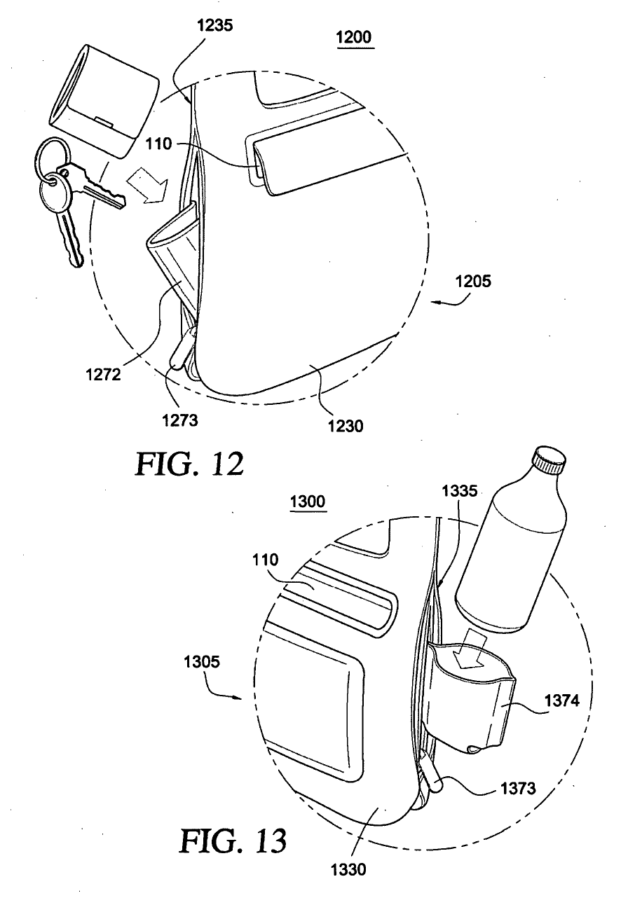

FIG. 12 illustrates an isometric view of an exemplary laptop computer carrying article 1200 according to an eighth embodiment of the invention. Article 1200 can be similar to, for example, article 100 (FIGS. 1-3), article 400 (FIG. 4), article 500 (FIG. 5), article 600 (FIG. 6), and/or article 700 (FIGS. 7-9). Article 1200 comprises an accessory pocket 1272 between a front side 1235 and a back side 1230. Accessory pocket 1272 can be accessible from outside of a body 1205 independently of, or without having to go through, non-secured opening 110. Accessory pocket 1272 can be stored or tucked within body 1205 when accessory pocket 1272 is not in use. A securing mechanism 1273, such as a zipper, can be used to secure accessory pocket 1272 within body 1205. Accessory pocket 1272 provides a user with the benefit of being able to quickly access personal items such as keys, a wallet, and the like. In one embodiment, accessory pocket 1272 can be similar to accessory pocket 355 in FIG. 3.

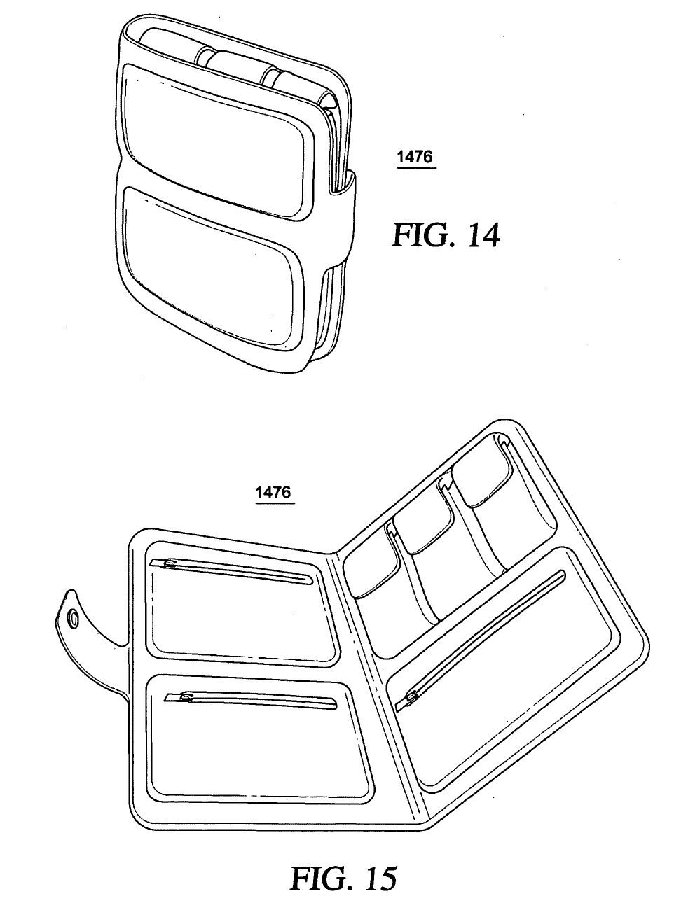

FIG. 13 illustrates an isometric view of an exemplary laptop computer carrying article 1300 according to a ninth embodiment of the invention. In some embodiments, article 1300 can be similar to, for example, article 100 (FIGS. 1-3), article 400 (FIG. 4), article 500 (FIG. 5), article 600 (FIG. 6), and/or article 700 (FIGS. 7-9). Article 1300 comprises bottle holder 1374 between a front side 1335 and a back side 1330. Bottle holder 1374 can be accessible from outside a body 1305 independently of, or without having to go through, non-secured opening 110. Bottle holder 1374 can be stored or tucked within body 1305 when bottle holder 1374 is not in use. In some example, bottle holder 1374 can be secured within body 1305 by a securing mechanism 1373, such as a zipper. Bottle holder 1374 provides a user with the benefit of being able to quickly access a bottle, such as water bottle. As an example, bottle holder 1374 can be similar to bottle holder 350 in FIG. 3. In some examples, bottle holder 1374 and/or accessory pocket 1272 can be referred to as stowable compartments.

FIG. 14 illustrates an isometric view of an accessory folder 1476 for an exemplary laptop computer carrying article according to a tenth embodiment of the invention. Folder 1476 can be removably stored within an article, for example article 100 (FIGS. 1-3), article 400 (FIG. 4), article 500 (FIG. 5), article 600 (FIG. 6), etc., to provide a user with additional or compartmentalized storage of personal items and/or computer accessories. FIG. 15 illustrates accessory folder 1476 in an open configuration to illustrate various possible internal storage compartments of accessory folder 1476.

As shown among the various figures, article 100 of FIGS. 1-3, article 400 (FIG. 4), article 500 (FIG. 5), article 600 (FIG. 6), article 700 (FIGS. 7-9), article 1200 (FIG. 12), and article 1300 (FIG. 13) comprise configurations commensurate with a shoulder bag or a back pack configuration. Other exemplary embodiments, however, are contemplated having other size and shape configurations. For example, other embodiments can comprise different sizes to accommodate different sized computers, or different sizes can be used to accommodate different individual users, such as, one size for adults and another size for children. Also, other shape configurations can be used to accommodate the various aesthetic preferences among users. Furthermore, various exemplary embodiments can comprise various materials and design configurations to additionally personalize or tailor for a specific use the articles.

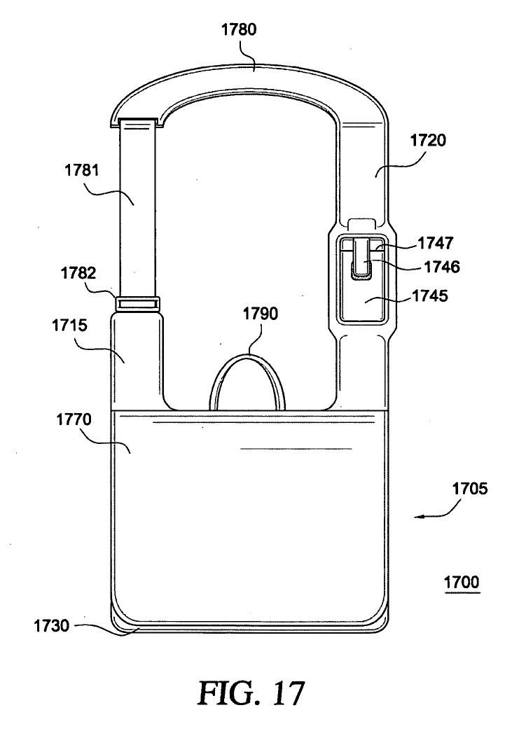

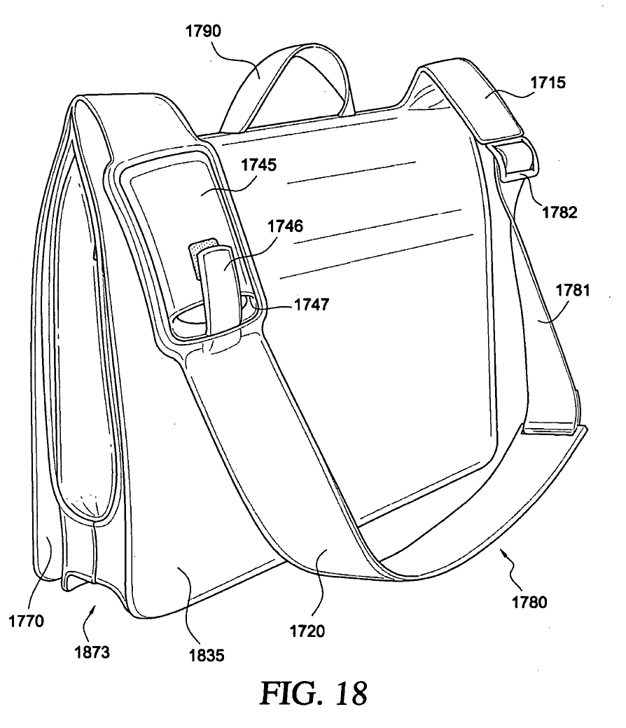

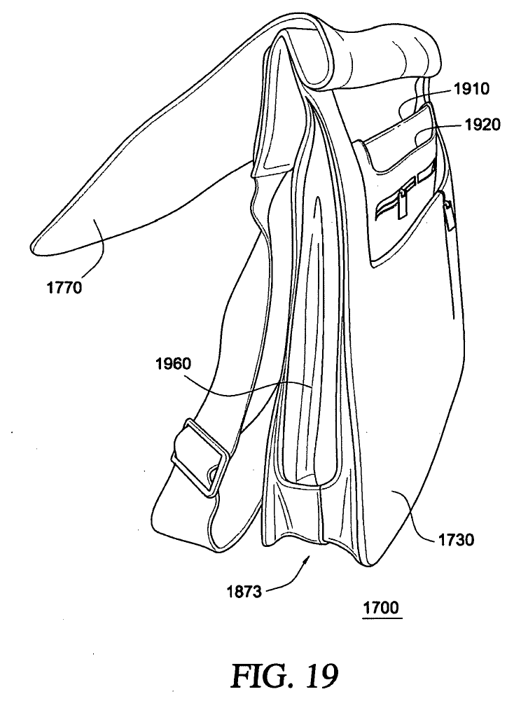

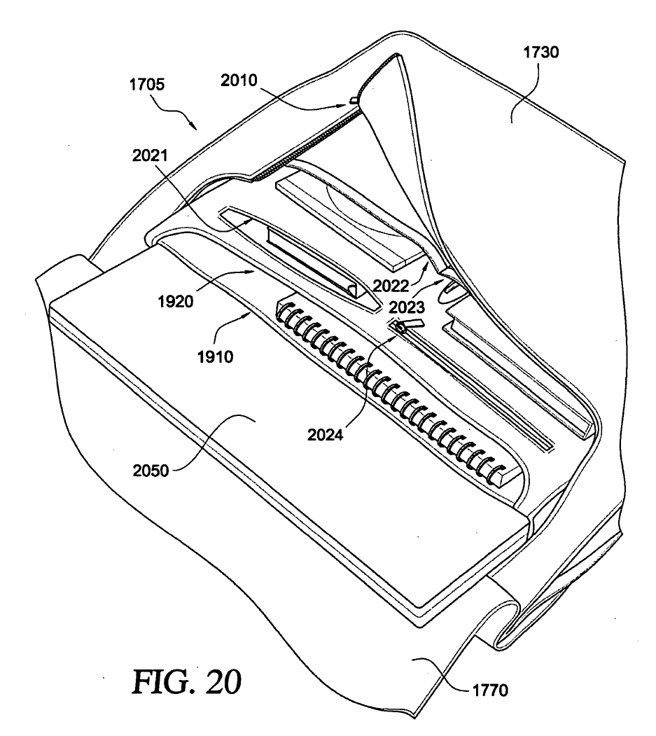

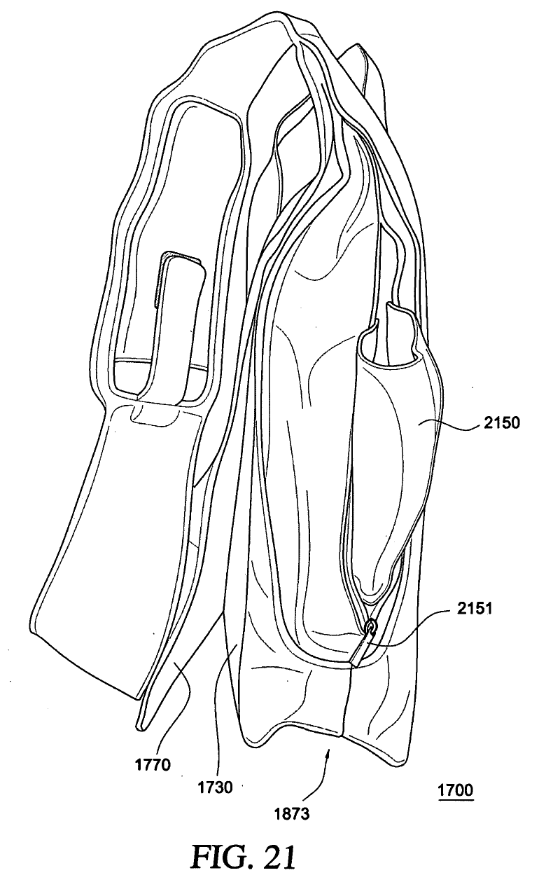

Skipping ahead in the figures, FIG. 17 illustrates an embodiment of an exemplary laptop computer carrying article 1700. FIG. 18 illustrates a front isometric view of article 1700 with flap 1770 closed. FIG. 19 illustrates a rear isometric view of article 1700 with flap 1770 open. FIG. 20 illustrates a view of compartments inside article 1700. FIG. 21 shows a side view of article 1700 showing stowable compartment 2150 as exposed.

Article 1700 can be similar to article 100 of FIGS. 1-3, article 400 (FIG. 4), article 500 (FIG. 5), article 600 (FIG. 6), article 700 (FIGS. 7-9), article 1200 (FIG. 12), and article 1300 (FIG. 13). For example, article 1700 comprises flap 1770, similar to flap 670 of article 600 (FIG. 6), but differing by substantially covering side 1730 of body 1705. In this embodiment, the interior or exterior surface of flap 1770 can comprise padding, similar to padding 140 in FIG. 1. The padding of flap 1770 can be in addition to or in place of padding 140 in FIG. 1. In addition, article 1700 comprises single support strap 1780. In the present example, single support strap 1780 comprises support straps 1715, 1720, and 1781 coupled together in a substantially permanent fashion, and a length of single support strap 1780 is configured to be adjustable via slideloop 1782. In other embodiments, support straps 1715, 1720, and/or 1781 can be separable from each other. In some embodiments, support straps 1715, 1720, and/or 1781 can be similar to straps 115, 120, and 125 (FIG. 1).

Article 1700 also comprises storage pocket 1745, similar to storage pocket 245 of article 100 (FIG. 2), and comprising opening 1747 secured by strap 1746. In some embodiments, strap 1746 can comprise hook and loop material to secure opening 1747 so that items placed within storage pocket 1745 do not slide out. Additionally, article 1700 comprises handle 1790 coupled to a top portion of body 1705 between sides 1730 and 1835. In a different embodiment, handle 1790 can be coupled to a first one of sides 1730 or 1835. In the same or a different embodiment, article 1700 can comprise another handle similar to handle 1790 but coupled to a second one of sides 1730 or 1735.

As shown in FIGS. 19-20, article 1700 comprises non-secured opening 1910. Non-secured opening 1910 can be similar to non-secured opening 110 (FIG. 1), and can be used to accommodate articles similar to laptop 2050 in sleeve 1960 of article 1700. Article 1700 also comprises other compartments 1920, 2021, 2022, 2023, and 2024, coupled to an exterior of sleeve 1960. In the present embodiment, side 1730 of article 1700 is configured to cover at least some of compartments 1920, 2021, 2022, and/or 2023. Also in the present embodiment, side 1730 also comprises access mechanism 2010 designed to permit separation of at least a portion of side 1730 from body 1705 to Facilitate access to the at least some of compartments 1920, 2021, 2022, and/or 2023. Access mechanism 2010 can comprise exemplary materials such as zippers or elastics.

As illustrated in FIGS. 18, 19, and 21, article 1700 also comprises support element 1873 coupled proximate to the bottom of article 1700. Support element 1873 can be similar to support element 373 (FIG. 3), configured to maintain article 1700 in an upright position relative to a support surface when not worn by a user. As illustrated, support element 1873 lies between sides 1730 and 1835 of article 1700. In the same or a different embodiment, support element 1873 can also be similar to support element 363 (FIG. 3), and can be coupled within the interior of article 1700 to sleeve 1960. Article 1700 further comprises stowable compartment 2150, which can be similar to accessory pocket 1272 and/or bottle holder 1374 of FIGS. 12-13. Stowable compartment 2150 can be secured, when stowed in body 1705, by securing mechanism 2151, similar to securing mechanisms 1273 and 1373 (FIGS. 12-13).

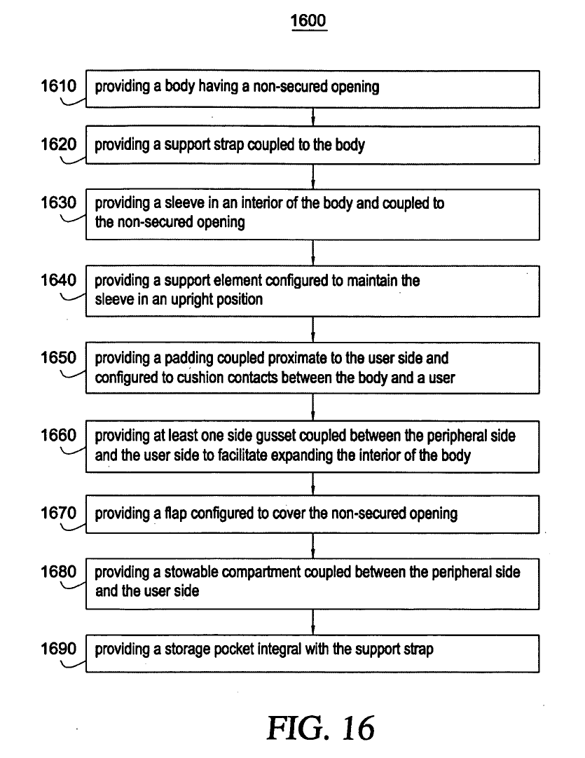

Backtracking through the figures, FIG. 16 depicts a flow diagram representation of a method 1600 for manufacturing a laptop computer carrying article, according to an example of the present invention. Method 1600 comprises providing a body having a non-secured opening (block 1610), providing a support strap coupled to the body (block 1620), and providing a sleeve in an interior of the body and coupled to the non-secured opening (block 1630).

In some examples of method 1600, providing a support strap coupled to the body (block 1620) can further comprise providing a strap set of two or more straps coupled together to form the support strap, and/or providing a slideloop coupled to the support strap and configured to adjust an overall length of the support strap. Some examples of block 1620 of method 1600 can also comprise providing a second support strap coupled to the body wherein the first support strap couples to the body proximate to opposite ends of a first lateral portion, the second support strap couples to the body proximate to opposite ends of a second lateral portion. Such an embodiment can be use to manufacture a laptop computer carrying article that could be carried, for example, as a backpack. Also, in the same or a different embodiment, blocks 1610 and 1620 can be performed simultaneously with each other.

In some embodiments of method 1600, the non-secured opening is configured to have dimensions at least as large as at least two of a laptop width, a laptop height, and a laptop thickness, where the laptop dimensions can be determined based on average or target dimensions of a particular laptop or of laptops current sold in the marketplace. In one example of method 1600, the body of the laptop computer carrying article further comprises a peripheral side having a substantially uninterrupted surface, and a user side opposite the peripheral side and comprising the non-secured opening. In the same or a different example, the support strap can be integral with at least one of the peripheral side and the user side. In some examples, the sleeve is configured to accommodate the laptop width, the laptop height, and the laptop thickness. The sleeve can also be removable and/or cushioned.

Continuing through FIG. 16, method 1600 can further comprise providing a support element configured to maintain the sleeve in an upright position (block 1640). In some examples, the support element of block 1640 can be similar to support elements 363, 373 (FIG. 3), and/or 1873 (FIG. 18). Method 1600 can also comprise, in some examples, providing a padding coupled proximate to the user side and configured to cushion contacts between the body and a user (block 1650). In the same or a different example, method 1600 can also comprise providing at least one side gusset coupled between the peripheral side and the user side to facilitate expanding the interior of the body (block 1660). Method 1600 can further comprise providing a flap configured to cover the non-secured opening (block 1670) in some embodiments.

In at least some examples, method 1600 can comprise providing a stowable compartment coupled between the peripheral side and the user side body (block 1680). The stowable compartment can comprise at least one of an accessory pocket and a bottle holder in some embodiments, where the stowable compartment is accessible from outside the body independent of the non-secured opening, and the stowable compartment is further configured to be stored within the body when not in use. In some embodiments, method 1600 can also comprise providing a storage pocket integral with the support strap (block 1690), where the pocket storage pocket can be configured to support an electronic devices such as a cell phone or a digital music player within easy reach of a user.

Although a particular order is illustrated for the blocks shown in FIG. 16, these blocks may be performed in other temporal sequences. At least some of the blocks depicted in FIG. 16 may be performed sequentially, concurrently, in reverse order, or the like. Some of the blocks may also be optional. For example, block 1670 can be optional in some examples, or can performed before or after its present relative location in other examples.

Additional examples of similar or other implementations have been given in the foregoing description. Accordingly, the disclosure of embodiments of laptop computer carrying articles and methods of manufacture thereof is intended to be illustrative of the scope of the laptop computer carrying articles and methods of manufacturing the same, and is not intended to be limiting. For example, in one embodiment, the laptop computer carrying articles and/or methods of manufacturing the same can have one or more features of FIG. 3, with or without the features described with reference to FIGS. 10 and 12-14. Other permutations of the different embodiments having one or more of the features of the various figures are likewise contemplated. It is intended that the scope of such laptop computer carrying articles and methods of manufacturing the same shall be limited only to the extent required by the appended claims.

The laptop computer carrying articles and methods of manufacturing the same that are discussed herein can be implemented in a variety of embodiments, and the foregoing discussion of these embodiments does not necessarily represent a complete description of all possible embodiments. Rather, the detailed description of the drawings, and the drawings themselves, disclose at least one preferred embodiment of laptop computer carrying articles and methods of manufacturing the same, and can disclose alternative embodiments the laptop computer carrying articles and methods of manufacturing the same.

All elements claimed in any particular claim are essential to the laptop computer carrying articles and methods of manufacturing the same, as claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An article for carrying a laptop computer, the article comprising:
a body having a non-secured opening, and
a support strap coupled to the body;
wherein:
the non-secured opening comprises dimensions at least as large as at least two of a laptop width, a laptop height, or a laptop thickness;
the body further comprises:
a first side having a substantially uninterrupted surface; and
a second side opposite the first side and comprising the non-secured opening; and
the support strap is integral with at least one of the first or second sides of body.

2. The article of claim 1, further comprising:
a sleeve in an interior of the body and coupled to the non-secured opening;
wherein the sleeve is configured to house the laptop computer.

3. The article of claim 2, wherein the sleeve is removable.

4. The article of claim 3, wherein the sleeve comprises a cushioning material.

5. The article of claim 4, further comprising:
a support element coupled proximate to a bottom of the sleeve and configured to maintain the sleeve in an upright position.

6. The article of claim 1, further comprising:
a support element coupled proximate to a bottom of the body and configured to maintain the article in an upright position.

7. The article of claim 6, wherein:
the support element comprises:
a first support region;
a second support region; and
a support spine between the first and second support regions;
the first and second support regions are configured to:
support the article in the upright position over a support surface; and
maintain the support spine off the support surface; and
the support spine is configured to restrict at least a portion of the article from bulging towards the support surface.

8. The article of claim 1, wherein:
the second side comprises a padding configured to cushion contact between the body and a user.

9. The article of claim 1, further comprising:
at least one side gusset coupled between the first side and the second side to facilitate expanding the interior of the body.

10. The article of claim 1, further comprising:
a flap configured to cover the non-secured opening.

11. The article of claim 10, wherein:
the flap is configured to substantially cover the second side of the body.

12. The article of claim 1, further comprising:
an accessory pocket coupled between the first and second sides of the body;
wherein:
the accessory pocket is accessible from outside the body independent of the non-secured opening, and
the accessory pocket is configured to be stored within the body when not in use.

13. The article of claim 1, further comprising:
a bottle holder coupled between the first and second sides of the body,
wherein:
the bottle holder is accessible from outside the body independent of the non-secured opening, and
the bottle holder is configured to be stored within the body when not in use.

14. The article of claim 1, further comprising:
a storage pocket integral with the support strap.

15. The article of claim 1, wherein:
the support strap comprises at least a first strap and a second strap coupled together.

16. The article of claim 15, wherein:
the first and second straps are coupled together in a substantially permanent manner.

17. The article of claim 15, wherein:
each of the first and second straps comprise an arcuate shape.

18. The article of claim 15, further comprising:
a third strap coupled to and between the first and second straps.

19. The article of claim 18, wherein the third strap comprises at least one of:
an arcuate shape; or
a trapezoidal shape.

20. The article of claim 1, wherein:
an overall length of the support strap is configured to be adjustable via a slideloop coupled to the support strap.

21. The article of claim 1, further comprising:
a second support strap coupled to the body;
wherein:
the support strap couples to the body proximate to opposite ends of a first lateral portion of the body; and
the second support strap couples to the body proximate to opposite ends of a second lateral portion of the body.

22. The article of claim 21, further comprising:
a first adjustment strap coupled to and between the support strap and one of the opposite ends of the first lateral portion of the body; and
an second adjustment strap coupled to and between the second support strap and one of the opposite ends of the second lateral portion of the body.

23. The article of claim 1, further comprising:
a removable accessory folder configured to fit within the interior of the body.

24. The article of claim 1, wherein:
the non-secured opening is not visible to a non-user when a user wears the article.

25. The article of claim 1, wherein:
the first side is configured to face away from a user when the user wears the article; and
the second side is configured to face towards the user when the user wears the article.

26. The article of claim 1, further comprising:
at least one handle coupled proximate to a top portion of the article.

27. A method for manufacturing an article for carrying a laptop computer, the method comprising:
providing a body having a non-secured opening; and
providing a support strap coupled to the body;
providing a sleeve in an interior of the body and coupled to the non-secured opening;
wherein:
the non-secured opening comprises dimensions at least as large as at least two of a laptop width, a laptop height, and a laptop thickness;
the body further comprises:
a peripheral side having a substantially uninterrupted surface; and
a user side opposite the peripheral side and comprising the non-secured opening;
the support strap is integral with at least one of the peripheral side or the user side;
the sleeve is configured to accommodate the laptop width, the laptop height, and the laptop thickness; and
the sleeve is at least one of:
removable; or
cushioned.

28. The method of claim 27, further comprising:
providing a support element configured to maintain the sleeve in an upright position;
wherein the support element is coupled proximate to at least one of:
a bottom of the sleeve; or
a bottom of the body.

29. The method of claim 28, wherein:
providing the support element comprises:
providing a first support region;
providing a second support region; and
providing a support spine between the first and second support regions;
the first and second support regions are configured to:
support the article in the upright position over a support surface; and
maintain the support spine off the support surface; and
the support spine is configured to restrict at least a portion of the article from bulging towards the support surface.

30. The method of claim 27, further comprising:
providing a padding coupled proximate to the user side and configured to cushion contact between the body and a user.

31. The method of claim 27, further comprising:
providing at least one side gusset coupled between the peripheral side and the user side to facilitate expanding the interior of the body.

32. The method of claim 27, further comprising:
providing a flap configured to cover the non-secured opening.

33. The method of claim 27, further comprising:
providing a stowable compartment coupled between the peripheral side and the user side;
wherein:
the stowable compartment comprises at least one of:
an accessory pocket; or
a bottle holder;
the stowable compartment is accessible from outside the body independent of the non-secured opening, and
the stowable compartment is configured to be stored within the body when not in use.

34. The method of claim 27, further comprising:
providing a storage pocket integral with the support strap.

35. The method of claim 27, wherein:
providing the support strap comprises:
providing a strap set of two or more straps coupled together to form the support strap.

36. The method of claim 27, further comprising:
providing a slideloop coupled to the support strap and configured to adjust an overall length of the support strap.

37. The method of claim 27, further comprising:
providing a second support strap coupled to the body;
wherein:
the first support strap couples to the body proximate to opposite ends of a first lateral portion; and
the second support strap couples to the body proximate to opposite ends of a second lateral portion.

38. An article for carrying a laptop computer, the article comprising:
a body comprising:
a first side having a substantially uninterrupted surface; and
a second side opposite the first side;
a sleeve coupled to an interior of the body;
a non-secured opening coupled to the sleeve;
a flap coupled to the body;
a support strap coupled to the body;
a support element coupled proximate to a bottom of the body and comprising:
a first support edge;
a second support edge; and
a support spine between the first and second support edges;
a stowable compartment coupled between the first and second sides and comprising at least one of an accessory pocket or a bottle holder,
a storage pocket integral with the support strap; and
at least one handle coupled proximate to a top portion of the article;
wherein:
the non-secured opening comprises dimensions at least as large as at least two of a laptop width, a laptop height, or a laptop thickness;
the flap is configured to substantially cover the non-secured opening and the second side of the body;
the support strap is integral with at least one of the first or second sides of body;
the sleeve comprises a cushioning material and is configured to house the laptop computer,
the stowable compartment is accessible from outside the body independent of the non-secured opening;
the stowable compartment is configured to be stored within the body when not in use;
an overall length of the support strap is adjustable;
the non-secured opening is configured to be invisible when the article is worn;
the first and second edges are configured to:
maintain an upright balance of the article; and
raise the support spine off the support surface;
the first edge is configured to sustain a first portion of a weight of the article along a first axis over a support surface;
the second edge is configured to sustain a second portion of the weight of the article along a second axis over the support surface; and
the support spine is configured to restrict a deformation of a portion of the article from affecting the upright balance of the article.
